(19) United States
(12) Patent Application Publication
(10) Pub. No.: US 2008/0164086 A1
(43) Pub. Date: Jul. 10, 2008

(54) SELF-PROPELLED VEHICLE

(75) Inventor: Kwun-Mao Ho, Taoyuan (TW)

Correspondence Address: WPAT, PC, 7225 BEVERLY ST., ANNANDALE, VA, 22003, US

(73) Assignee: CHUNG YUAN CHRISTIAN UNIVERSITY, Taoyuan (TW)

(21) Appl. No.: 11/758,744

(22) Filed: Jun. 6, 2007

(30) Foreign Application Priority Data
Jan. 8, 2007 (TW) 096200299

(51) Int. Cl. B62D 61/06

(52) U.S. Cl. 180/214

(57) ABSTRACT

A self-propelled vehicle is provided, including a rotatable power base comprising two main wheels and at least one auxiliary wheel, the two main wheels being connected to two sides of a power base, the at least one auxiliary wheel being disposed underneath the power base, wherein the rotatable power base further includes a differential for connecting and controlling the two main wheels, thereby, the rotatable power base can be rotate 360 degrees; a connecting module having a first end and a second end, the first end being connected to the rotatable power base; a carrying module connecting to the second end of the connecting module; and a control module being secured to the carrying module for controlling operations of the rotatable power base and the connecting module. Accordingly, time spent on standing and walking by operators can be reduced while increasing work efficiency.

### BACKGROUND OF THE INVENTION

1. Field of the Invention

The present invention generally relates to transportation, and more particularly, a self-propelled vehicle.

2. Description of the Prior Art

Electrical motor cars commonly used by elder or physically challenged people usually have a radius of gyration, which makes them not suitable for use in confined spaces or homes. The present invention may reduce this inconvenience.

Many personnel working in factories are required to wear anti-static garments and often stand in front of machines for a long time or move between different machines to manage and operate the machines. In traditional industries, there are also big factories that require personnel to constantly walk around in order to attend or operate his/her machines.

However, staff standing for long durations or walking around constantly may get tired easily, which lowers the work efficiency. Moreover, staff sometimes have to carry raw materials or products with them when moving around, which is even more exhausting.

In view of the shortcomings in the prior art, the present invention discloses a self-propelled vehicle that can be controlled by the staff themselves, so that the staff can easily move between operating machines at their will. Additionally, it can assist the staff in transporting more raw materials or products.

### SUMMARY OF THE INVENTION

In view of the prior art and the needs of the related industries, the present invention provides a self-propelled vehicle that meets the requirement of the related industries.

One objective of the present invention is to provide a self-propelled vehicle, including a rotatable power base comprising two main wheels and at least one auxiliary wheel, the two main wheels being connected to two sides of a power base, the at least one auxiliary wheel being disposed underneath the power base, wherein the rotatable power base further includes a differential for connecting and controlling the two main wheels, thereby, the rotatable power base can be rotate 360 degrees; a connecting module having a first end and a second end, the first end being connected to the rotatable power base; a carrying module connecting to the second end of the connecting module; and a control module being secured to the carrying module for controlling operations of the rotatable power base and the connecting module. Accordingly, time spent on standing and walking by operators can be reduced while increasing work efficiency.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a schematic diagram depicting general modules of a preferred embodiment of the present invention;

FIG. 2 is a perspective view of a preferred embodiment of the present invention;

FIG. 3A is a schematic diagram depicting the front side of the embodiment of FIG. 2; and

FIG. 3B is a schematic diagram depicting the bottom view of a preferred power base of the present invention.

### DETAILED DESCRIPTION OF THE PREFERRED EMBODIMENTS

The present invention is directed to a self-propelled vehicle. Detailed steps and constituents are given below to assist in the understanding the present invention. Obviously, the implementations of the present invention are not limited to the specific details known by those skilled in the art. On the other hand, well-known steps or constituents are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

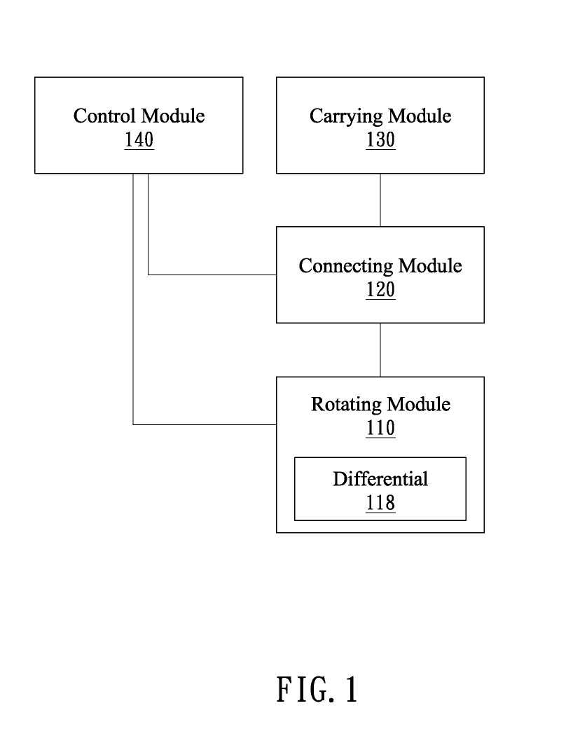

Referring to FIG. 1, a schematic diagram depicting general modules of a preferred embodiment of the present invention is shown. This embodiment includes a rotatable power base 110, a connecting module 120, a carrying module 130 and a control module 140. The rotatable power base 110 provides a structure capable of transportation for the self-propelled vehicle, such as a base structure, a bearing, a revolving speed control, electric motor, secondary cell etc. The rotatable power base 110 can further comprise a differential 118 for controlling wheels of the self-propelled vehicle of the present invention, such that they can move with ease. The carrying module 130 is used to provide room for staff, raw material or final product. The connecting module 120 is connected to the rotatable power base 110 and the carrying module 130. The control module 140 is used to control operations of the rotatable power base 110 and the connecting module 120 via a control medium or control circuit.

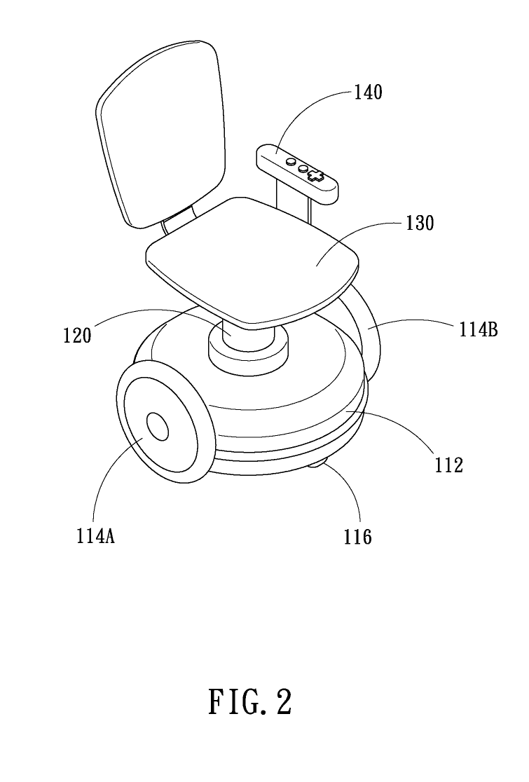

Referring to FIG. 2, a perspective view of a preferred embodiment of the present invention is shown. A rotatable power base 110 (FIG. 1) includes a power base 112, two main wheels 114A and 114B and at least one auxiliary wheel 116. Two main wheels 114A and 114B are connected to two sides of the power base 112, whereas the auxiliary wheel 116 is connected underneath the power base 112. The rotatable power base 110 also includes a differential 118 (FIG. 1) for connecting and controlling the two main wheels 114A and 114B. The power base 112 can be more easily rotated due to the difference in speed of the two main wheels 114A and 114B. In this embodiment, the auxiliary wheel 116 may include a 360-degree rotatable pulley. When there is only one pulley, it can be located in such a way as to form an isosceles triangle with the two main wheels 114A and 114B at the bottom of the power base 112. In this way, the power base 112 can be balanced while cost is reduced. When there are two pulleys, the auxiliary wheel 116 can be arranged opposite to each other to increase flexibility of the power base 112 during rotation.

In this embodiment, the carrying module 130 shown in FIG. 1 may be a rotatable chair (as shown in FIG. 2), or a material container with a top opening for containing materials. The connecting module 120 shown in FIG. 1 may be a vertically shifting bearing (as shown in FIG. 2), which can be connected to the rotatable power base (power base 112) at a first end thereof and connected to the carrying module 130 (i.e. the rotatable chair) at a second end thereof. The control module 140 shown in FIG. 1 can be integrated and secured in the carrying module 130 (e.g. an arm of the rotatable chair) for convenient operation. The control module 140 may also be a wireless remote and a wireless receiver, wherein the wireless receiver is secured in the carrying module 130 or the rotatable power base 110, and a staff may use the wireless remote to control the traveling direction and the speed of the rotatable power base 110 and the vertical shifting of the connecting module 120.

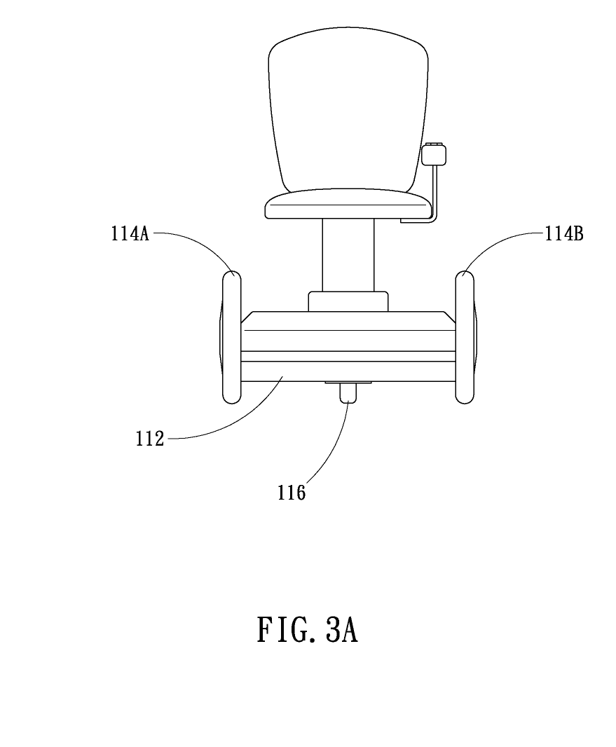

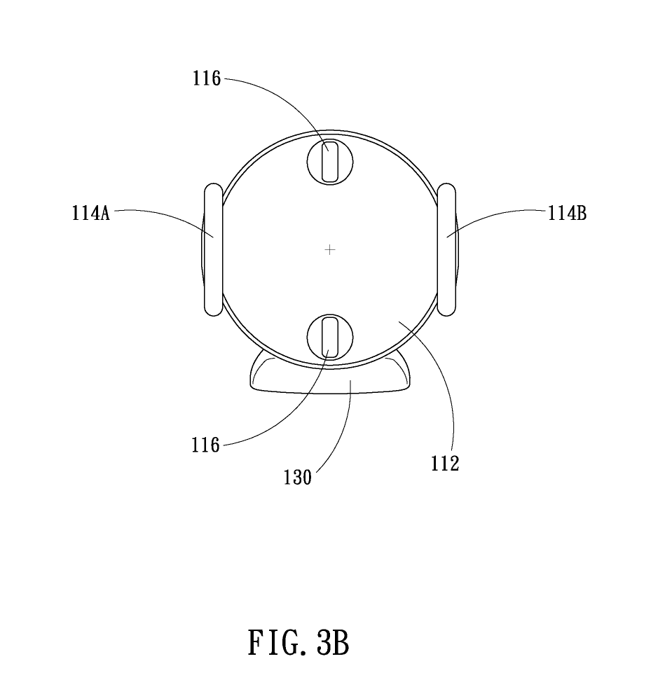

Please refer to FIG. 3A, a schematic diagram depicting the front side of the embodiment of FIG. 2 is shown. The two main wheels 114A and 114B are located at two sides of the power base 112, while the auxiliary wheel 116 is located underneath the power base 112 and forms an isosceles triangle with the two main wheels 114A and 114B, so as to support the self-propelled vehicle of the present invention. Referring now to FIG. 3B, a schematic diagram depicting the bottom view of a preferred power base of the present invention is shown. In this embodiment, there are two auxiliary wheels 116 arranged opposite to each other, and form four supporting points along with the two main wheels 114A and 114B for supporting the self-propelled vehicle of the present invention. Accordingly, the center of gravity of the power base 112 can be more stable while increasing the flexibility of the power base 112 during rotation.

Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

1. A self-propelled vehicle, including:
a rotatable power base comprising two main wheels and at least one auxiliary wheel, the two main wheels being connected to two sides of a power base, the at least one auxiliary wheel being disposed underneath the power base, wherein the rotatable power base further includes a differential for connecting and controlling the two main wheels;
a connecting module having a first end and a second end, the first end being connected to the rotatable power base;
a carrying module connecting to the second end of the connecting module; and
a control module being secured to the carrying module for controlling operations of the rotatable power base and the connecting module.

2. A self-propelled vehicle of claim 1, wherein the at least auxiliary wheel includes at least one 360-degree rotatable pulley.

3. A self-propelled vehicle of claim 1, wherein the number of the at least auxiliary wheel includes two.

4. A self-propelled vehicle of claim 1, wherein the connecting module includes a bearing capable of shifting in the vertical direction.

5. A self-propelled vehicle of claim 1, wherein the carrying module includes a rotatable chair.

6. A self-propelled vehicle of claim 1, wherein the control module includes a wireless remote and a wireless receiver, wherein the wireless receiver is secured to the carrying module.
